(19) United States
(12) Patent Application Publication
(10) Pub. No.: US 2017/0095973 A1
(43) Pub. Date: Apr. 6, 2017

(54) Cable Driven Manipulator for Additive Manufacturing

(71) Applicant: Worcester Polytechnic Institute, Worcester, MA (US)

(72) Inventors: Sarah M. Chamberlain, Albany, NY (US); Richard T. Eberheim, Mechanicsville, VA (US)

(21) Appl. No.: 15/286,942

(22) Filed: Oct. 6, 2016

Related U.S. Application Data
(60) Provisional application No. 62/237,670, filed on Oct. 6, 2015.

(51) Int. Cl. B29C 67/00; B33Y 50/02; B33Y 30/00; B28B 1/00; B33Y 10/00

(52) U.S. Cl. CPC B29C 67/0055; B29C 67/0088; B28B 1/001; B33Y 10/00; B33Y 30/00; B33Y 50/02; B29K 2105/12

(57) ABSTRACT

A parallel robotic manipulator for generating 3 dimensional structures includes a set of redeployable towers adapted to transport one or more cables, and at least one drive source operable to draw or traverse the cables across a rendering area. An end-effector suspended from the cables is operable to deposit extrudate onto the rendering area, and a nozzle in the end-effector is configured to selectively deposit the extrudate at predefined locations based on the position of the cable. A control unit has control logic for directing the drive source, in which the cables are responsive to the drive source for disposing the end-effector either along the cables or drawn and extended from the towers. An extrudate reservoir and a pump in fluidic communication with the reservoir allows the pump to force the extrudate for deposition at the predefined location responsive to the control logic.

### RELATED APPLICATIONS:

This application claims the benefit under 35 U.S.C. §119(e) of U.S. Provisional Patent Application No. 62/237,670, filed Oct. 6, 2015, entitled “ CABLE DRIVEN MANIPULATOR FOR ADDITIVE MANUFACTURING,” incorporated herein by reference in entirety.

### BACKGROUND

Printing technology has evolved in recent decades to support various mediums for generating traditional hardcopy output from electronic sources, typically a computer program. Modern output rendering includes high resolution graphics, full color, and machine readable codes such as bar and square codes readable by optical scanning. 3-dimensional (3D) printing is evolving to allow rendering of small objects by controlled emission or extrusion of a sufficiently solid substance.

Additive manufacturing leverages 3D printing for replacing conventional manufacturing and fabrication by providing an alternative to components which would otherwise be formed by molding or machining, for example. A 3D printing apparatus directs a “printed” or formed material, in contrast to ink deposition as in 2D printing, and aggregates formed objects due to the thickness of the material. The conventional 3D printing approach directs a print head mounted in a frame on tracks or guides corresponding to the length, width and depth of the printing volume in the frame.

### SUMMARY

A cable driven parallel manipulator for generating 3-dimensional (3D) structures includes an arrangement of towers adapted to transport one or more cables, and at least one drive source operable to draw or traverse the cables across a rendering area. An end-effector suspended from the cables is operable to deposit extrudate (extruded material) onto the rendering area, and a nozzle in the end-effector is configured to selectively deposit the extrudate at predefined locations based on the position of the cable. A control unit has control logic for directing the drive source, in which the cables are responsive to the drive source for disposing the end-effector either along the cables or drawn and extended from the towers. An extrudate reservoir and a pump in fluidic communication with the reservoir allows the pump to force the extrudate for deposition at the predefined location responsive to the control logic.

At present, large scale additive manufacturing is complicated by the need to have a large and cumbersome structure to support a relatively small end effector. Configurations disclosed below utilize the advantages of a cable driven parallel manipulator to substantially overcome the problems associated with current additive manufacturing devices. The disclosed approach replaces a conventional fixed frame with 3 towers located at an outer region of a workspace or rendering area. A cable running from each tower is connected to the centrally located end effector. Motors located on the towers or the end effector operate as actuators to spool and unspool the cables to dispose the end effector throughout the workspace.

3D printing or additive manufacturing designs rely on a large supporting frame, are unable to be moved, are a fixed size, and cannot print on the final location. This design is relatively portable, much lower cost, and is capable of easily adapting to the environment in which it is placed. Conventional machines rely on large, immobile, and fixed size frames, and often these must be placed inside of an even larger structure, meaning that it is impossible for these machines to manufacture directly into the environment, and they cannot be easily moved or adjusted to accommodate new operations. Omission of a large, rigid frame and the ability to function without a large, permanent foundation provide greater versatility since the shape, size, and overall geometry of the printer can be adjusted to suit any workspace. Additionally, the simple suspended construction enables the erection, disassembly, and repositioning of the printer for redeployment with far reduced effort.

Configurations herein are based, in part, on the observation that controlled deposition of rendered material, common for hardcopy paper printing, has been extended to 3-dimensional (3D) printing by deposition of a structural material, rather than ink, onto a rendering area. Unfortunately, conventional approaches to 3D printing suffer from the shortcoming that printing or fabrication is limited to serial robotic manipulations inside a fixed frame. Print heads or other end-effectors for material deposition is controlled by serial manipulation along a rail or track suspended within the frame. Unfortunately, conventional approaches to 3D printing suffer from the shortcoming that each robotic element performs in a single degree-of-freedom (DOF), and a resulting print positon derived from an aggregation of the single DOF manipulations within the frame. Such an approach limits the finished fabrication product to a size dictated by the frame, and burdens print/fabrication accuracy and relative robotic mass of the apparatus from the use of serial manipulations.

Robotic and mechanized structures can be broadly classified, based on their architecture, as either serial or parallel. A serial robot is made up of a succession of rigid bodies from the base to the end-effector, each of them being linked to its predecessor and its successor by one-degree-of-freedom joint, typically to provide a pivot, rotation, or linear translation. Serial robots are typically characterized by a low load capacity-to-mass ratio and limited accuracy, but enjoy ease of design and subsequent kinematic analysis due to the relative simplicity of one degree of freedom at each joint segment. In contrast, configurations herein employ a parallel robotic arrangement. Such a parallel robot is made up of an end-effector with multiple degrees of freedom from a fixed base, linked together by at least two independent kinematics chains. Actuation takes place through the multiple simple actuators, therefore contributing to an integrated or combined kinetic influence on the end effector based on the multiple actuators. Conventional approaches do not provide for attachment of an end effector to various cable-driven parallel manipulators for a 3D extrusion nozzle.

In configurations herein, the set of support towers suspending the extruder over a rendering are is adapted for transition to a second rendering area for portability of the manipulator. In the example configuration, the frame includes three towers, each tower having a corresponding cable suspended therefrom, and the towers each have a drive source such as a winch for retracting and extending the cables. Alternatively, or in addition, the drive source includes at least one winch attached to the end-effector, such that each winch corresponds to a particular cable for drawing the winch and attached end-effector across the rendering area, thus the towers suspend the cable for traversal by a winch kinetically coupled to the end-effector.

The extrudate is a material or substance suitable for application to the rendering area for generating a desired dimensional structure, or object for fabrication, and may be a liquid form for dispensing and rendering, and subsequently achieve a solid or semi-solid state for support of subsequently applied extrudate.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a fabrication environment suitable for use with configurations disclosed herein that exhibits parallel manipulations of an end effector depositing extrudate for object fabrication;

FIG. 2 is a perspective view of the approach of FIG. 1 in fabrication use;

FIG. 3 shows cable actuators disposed in the extruder in the apparatus of FIG. 2;

FIG. 3A shows the extruder of FIG. 3 in greater detail;

FIG. 4 shows cable actuators disposed in the towers in the apparatus of FIG. 2; and

FIG. 5 shows a plan view of alternate arrangement of the approach of FIG. 2 using fixed cables traversed by the actuators.

### DETAILED DESCRIPTION

Depicted below is example of a frameless, cable driven parallel manipulator depicted by an extruder supported by the cables over the rendering area for precise deposition of extruded material for fabricating a desired form, structure or shape. A fabrication apparatus using the disclosed parallel manipulators is adapted for large scale fabrication since it is not bounded by a fixed frame for housing conventional serial manipulators.

The extruder, as employed herein, defines the end-effector of the actuator driven cables. The robotic term “end effector” generally refers to a device, manipulator or instrument at the end of a robotic member for interaction with the environment, depending on the application of the robot. It is the culmination of the movement and effects of the parallel or serial robotic translations for performing the task, measurement or operation that the robot was intended to perform. Therefore, the extruder is an end-effector of the parallel robotic manipulators defined by the towers and the actuators (winches).

As a conventional example, example, U.S. Pub. No. 2013/0292039 shows a fabricator supported by at least three elongated support members. It includes onboard actuators that translate the fabricator relative to the ends of the support members. However, the approach in '039 includes reservoirs or other storage devices for storing the material to be deposited (or ingredient(s) used in producing the deposited material onboard the fabricator. Thus, the '039 approach the suspended actuator contains all the materials for extruding/deposition. In contrast, the disclosed approach employs extrusion materials (extradite) in a separate reservoir and a feed pipe supplying the extruder, such that the extruder can be much lighter since it need not contain all the extruded material and mixing apparatus.

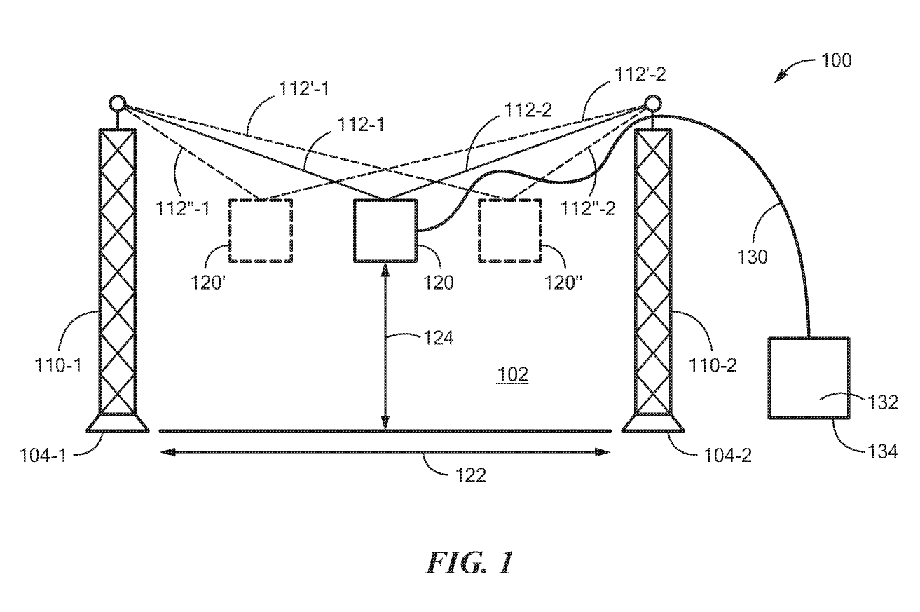

FIG. 1 is a context diagram of a fabrication environment suitable for use with configurations disclosed herein that exhibits parallel manipulations of an end effector depositing extrudate for additive manufacturing in fields such as construction and industrial machinery. Referring to FIG. 1, in a fabrication environment 100, a rendering area 102 is flanked by towers 110-1 . . . 110-2 (110 generally) each supporting a cable 112-1 . . . 112-2 (112 generally). The cables 112 support an extruder 120, or end-effector. Thus, the apparatus for forming additive structures includes an extruder 120 attached to at least one cable and adapted for movement over a rendering area while supported by the cable 112. Combined movement of the cables 112, by extending or retracting, disposes the extruder 120 into positions 120′ or 120″ by altering the respective length of the cables 112′-1, 112″-1 and 112′-2, 112″-2, shown by dotted lines. Movement of the cables 112 therefore affects both a lateral position 122 and a height 124 of the extruder 120. A feed vessel 130 transports extrudate 132 material from a hopper 134 to the extruder 120 for deposition onto the rendering area 102.

In particular configurations, discussed further below, a plurality of cable support towers 110 may be disposed adjacent to the rendering area 102, such that each of the towers is adapted for supporting a respective cable. At least one cable actuator, and likely several, are in communication with a corresponding cable 112 and configured to dispose the extruder 120 over the rendering area 102. The feed vessel 130 couples to the extruder 120 and is configured to transport the extrudate 132 to the extruder 120 for controlled deposition onto the rendering area 102.

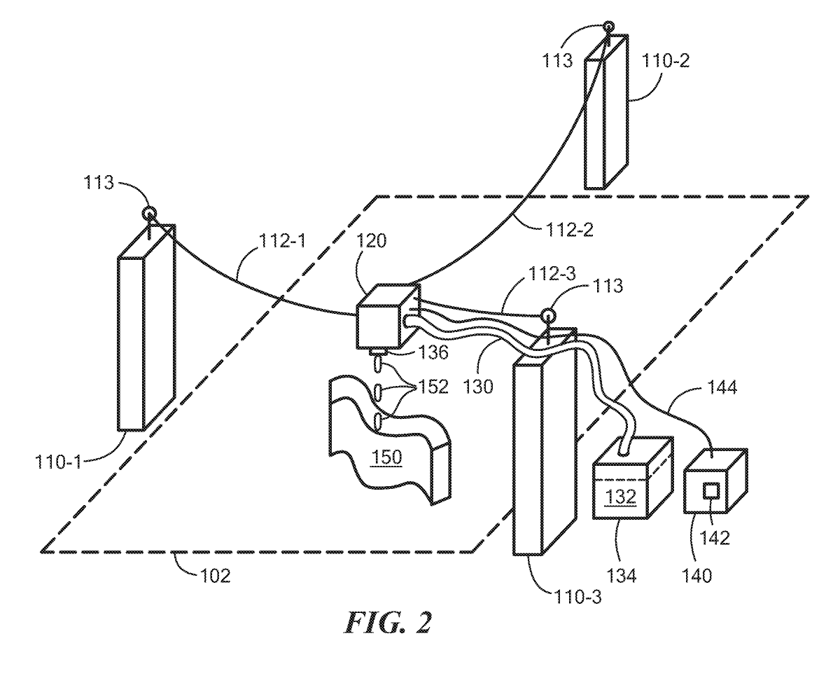

FIG. 2 is a perspective view of the approach of FIG. 1 in fabrication use. Referring to FIGS. 1 and 2, by employing 3 or more towers 110 and corresponding cables 112, lateral movement 122 may occur in two dimensions over the region defining the rendering area 102, and the third dimension defining the height 124. The feed vessel 130 is either sufficiently rigid and/or suspended from the towers 110 or cables 112 to avoid interference with extrudate deposition onto the rendering area 102. Fabrication logic 142 from a controller 140 controls actuators manipulating the cables 112 as well as the extruder 120 for depositing the extrudate (extruded material) to form a structure under fabrication 150, or fabricated object. The extruder 120 includes an extrusion pump for precise metering of extruded material 134 which forms the structure under fabrication 150.

The use of multiple actuators and cables 112 acting on a single end-effector defined by the extruder 120 provides parallel manipulations of the end effector. The parallel manipulator is therefore defined by a plurality of actuators, such that the extruder 120 defines an end-effector of the collective cable manipulations from each of the towers 110, in which the corresponding actuators contribute to the parallel manipulations of the extruder 120. Each of the actuators is responsive to a common control for positioning the extruder at a location defined by fabrication logic 142 in the controller 140. The position of the extruder 120 in the 3D space defined by the rendering area 102 is therefore controlled by adjusting a length of each cable 112 from the towers 110 to the extruder 120, which is performed by actuators in either the towers 110 or the extruder 120, discussed further below.

Continuing to refer to FIG. 2, the extruder 120 further includes a nozzle 136 in communication with the feed vessel 130 for receiving extrudate 132, and an extrusion pump 180 coupled to the nozzle 132 for dispensing precise quantities of extruded material 152 onto the rendering area 102 based on a position above the rendering area. The extrusion pump 180 may be operated by any suitable source, such as an electric motor or actuator in the extruder.

In contrast to conventional approaches, utilizing a fixed frame for supporting and containing all actuators, print heads and associated supports, the towers 110 are independently positioned on moveable bases 104-1 . . . 104-2 (FIG. 1, 104 generally), and may be readily deployed to define the rendering area 102 applicable to the structure under fabrication 150. Accordingly, the towers 110 are disposed outside a perimeter of the rendering area 102, such that the rendering area defines the limits of the fabricated structure 150 resulting from the extrusion operations of the extruder 120. Each of the towers 110, therefore, is a detached cable support and actuator 170, adapted to be disposed to an alternate location independently of the others of the plurality of towers. The rendering area 102 may be altered or enlarged by moving one, some or all of the bases 104 and corresponding towers 110.

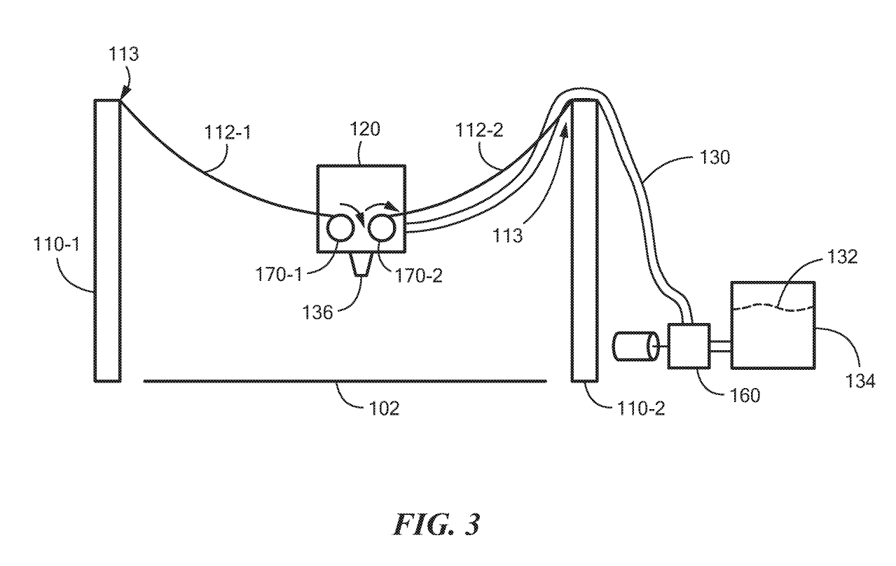

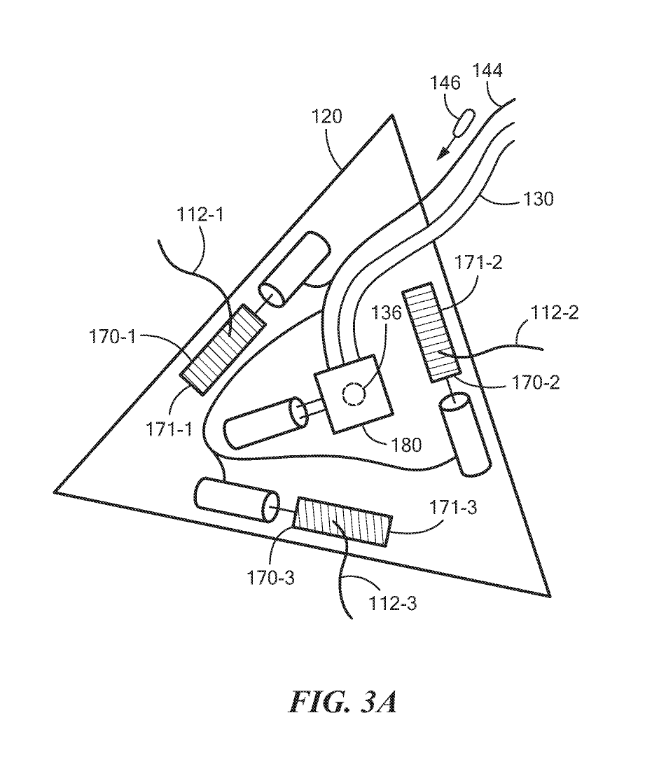

FIG. 3 shows cable actuators disposed in the extruder in the apparatus of FIG. 2. Referring to FIGS. 2 and 3, a plurality of cables 112 attaches to the extruder 120, each cable having a corresponding actuator 170 in the extruder, in which the actuators 170 are configured to spool the cable 112 to alter the length of the cable 112 to a respective tower 110. The actuators 170 provide parallel manipulations of the extruder 120 by disposing the extruder 120 over the rendering area 102 based on the unspooled length of each cable for three dimensional (3F) positioning over the rendering area. Therefore, the cable actuators 170 are disposed in the extruder 120, such that each cable has a corresponding cable actuator 170 and winds or unwinds the cable 112 from a spool driven by the actuator to modify the effective (unrolled) length of the cable to the corresponding tower. Each cable 112 further comprising an attachment 113 to a respective one of the plurality of towers 110, such that the extruder 120 is configured to traverse above the rendering area 102 by extending or retracting the cable relative to the respective tower 110.

A supply of extrudate 132 material is stored in a hopper 134 adjacent to the rendering area 102, and pumped to the extruder 120, rather than burdening the extruder 120 with a cargo of extrudate. The hopper 132 contains the extrudate 132 for forming a fabricated structure 150, and an extrudate pump 160 coupled to the hopper 134 is for transporting the extrudate through the feed vessel 130 attached to the extrudate pump 160 and suspended above the rendering area 102.

FIG. 3A shows the extruder of FIG. 3 in greater detail. The example of FIG. 3 shows a side elevation of a structure having two towers for clarity, and FIG. 3A shows a configuration with 3 cables corresponding to 3 towers 110, similar to the layout of FIG. 2. Any suitable number of towers 110 and actuators 170 may be employed, however at least 3 towers are employed when traversing a two dimensional rendering area 102 (with the third dimension begin height). In FIG. 3A, actuators 170-1 . . . 170-3 (170 generally) draw or extract a respective cable 112 onto a spool 171-1 . . . 171-3 (171 generally) to change the effective length of the cable 112 to the corresponding tower 110. Control signals 146 emanate from the fabrication logic 142 via a control bus 144, leading to each actuator 170 and the extrusion pump 180, fed by the feed vessel 130.

The extrusion pump 180 and actuators 170 are controlled by the fabrication logic 142 in the controller 140 for defining the limits of the rendering area 102 and for driving the actuators 170 and extruder 120 for additively forming the fabricated structure 150 by controlled extrusion of the extrudate 132 at predetermined locations in the rendering area 102. The fabrication logic 142 directs the actuators 170 to draw or extend the cables 112 to change the height and location of the extruder 120 to correspond to a predetermined program, plan or file containing specific parameters about the structure under fabrication 150. Any suitable parameters may be employed, depending on the precision of the extrusion pump 180 and granularity of control of the actuators 170, such a through stepper motors or other rotation control of the spooled cables 112.

The material from which the structure under fabrication 150 is formed may be any suitable material, stored initially in the hopper 134 as extrudate 132. The extrudate 132 flows through the feed vessel 130, forced by the extrudate pump 160 to the extruder 120, where the extrusion pump 180 deposits precisely controlled quantities of extruded material 152. The extrudate pump 160 is a high power cycled or continuous pump for moving the extrudate up through the feed vessel 130 and maintain a ready supply of extrudate to the extruder 120. The extrusion pump 180 performs finer control for metering specific amounts of extruded material as directed from the fabrication logic 142.

The extrudate 132 material is sufficiently fluid to flow through the feed vessel 130 and extrusion pump 180, yet sufficiently firm to maintain a structural firmness of the structure under fabrication 150. Typically a water or solvent based mixture would be employed to facilitate subsequent curing or drying. Concrete, plaster, gypsum, and/or polymer based materials provide some examples of extrudate. Additives such as chopped basalt fiber, frequently used as a low cost substitute for carbon fiber or rebar in concrete, may also be employed. The addition of the fiber enhances strength without sacrificing the excellent thermal and sound insulating properties of the extrudate 132. Sodium silicate, also known as “water glass” may also be added to the mixture for additional binding strength and reduced shrinkage during the setting process. Sodium Silicate can also be used for a number of purposes including as an extremely strong and waterproof adhesive resin, and as an excellent sealant.

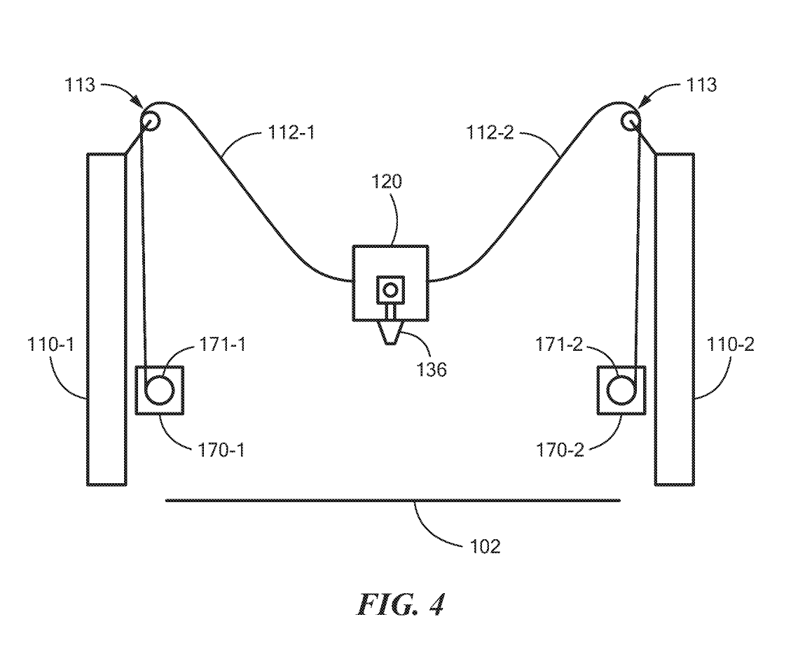

FIG. 4 shows cable actuators disposed in the towers in the apparatus of FIG. 2. Referring to FIGS. 2 and 4, an alternate approach disposes the actuators 170 on the towers, lessening the mass of the extruder 120. The example of FIG. 4, defines a cable actuator 170 at each of the towers 110, such that the cable 112 is engaged with the actuator 170 at a proximate end and attached to the extruder 170 at a distal end, such that the cable actuators 170 are adapted to dispose the extruder 120 for traversing the rendering area 102 by retracting or extending the cables. Each tower 110 has a respective cable 112 and actuator 170, such that each cable 112 attaches to the extruder 120 in a fixed manner for providing parallel manipulations of the extruder for three dimensional (3D) positioning over the rendering area 102. In the example of FIG. 4, the actuator 170 is defined by a winch at each of the towers 110, each winch being responsive to the fabrication logic 142, such that each of the actuators 170 is operable to drive the winch for spooling and unspooling the cable for disposing the extruder 120 at a height and location above the rendering area 102.

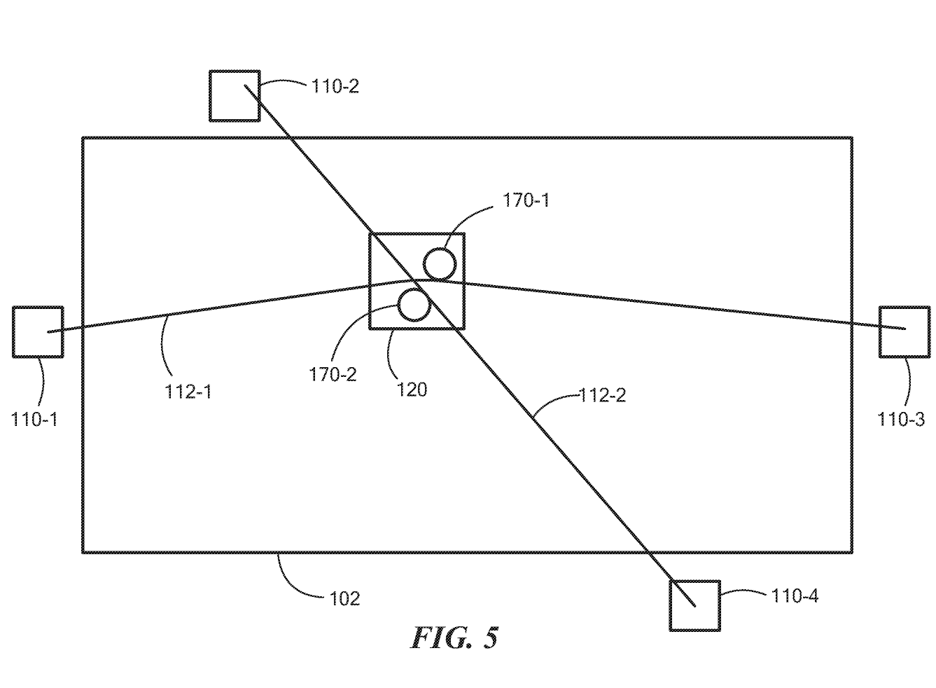

FIG. 5 shows a plan view of an alternate arrangement of the approach of FIG. 2 using fixed cables traversed by the actuators. In the example of FIG. 5, the cable actuators 170 are again disposed in the extruder 120, such that the cable further includes an attachment to a respective one of the plurality of towers. The extruder 120 is configured to traverse above the rendering area 102 by drawing the actuator along the cable toward or away from the respective tower. In FIG. 5, the extruder 120 mounted actuator 170 does not wind and accumulate the cable 110 around a spool 171, but rather traverses the length of the cable, drawing in on one side and expelling the cable on an opposed side such that the effective length of the cable on both sides remains constant. Positioning is performed by disposing the extruder 120 at an intersection of multiple cables 112.

In one configuration, the 3D fabrication approach disclosed herein is operable at remote sites for establishing dwelling structures. Such usage anticipates the 3D printer being used for the construction of the habitat is a cable driven parallel manipulator design. This type of design makes the printer lightweight, compact, portable, and scalable. The extruder 120 has four motorized winches, each connected with a cable to a support tower 110 positioned at the corners of the print or rendering area 102. The support towers 110 are large tripods, roughly 30 feet tall, to optimize stability and ease of setup. This design can be easily dismantled and reassembled in a new location to print additions or entirely new structures. The extrudate 132 is prepared by combining clay, basalt fiber, and water glass in an auger stirred container located near the printer. A peristaltic pump is used to pump the mixed extrudate through a pipe or feed vessel 130 to the extruder 120. Another auger in the extruder is used to force the material through the nozzle.

This configuration supports extraterrestrial colonization efforts through the use of an inflatable shell used during the printing process to conserve water by collecting water vapors that are released during the drying process. This shell would only be pressurized with planetary atmosphere enough to hold the shell up and is not otherwise climate controlled. The collected water is recycled back into the system to print the rest of the structure. After construction is complete the shell can be repurposed. The entire fabrication operation requires only a few days to complete. In the interest of preventing any chance of compromising the habitat's strength, the print would be scheduled to take place when the weather forecast is clear of any significant storms.

The controller 140, fabrication logic 142 and control bus 144 may be any suitable microprocessor based processor and transport platform. It will be appreciated by those skilled in the art that alternate configurations of the disclosed invention include a multiprogramming or multiprocessing computerized device such as a workstation, handheld or laptop computer or dedicated computing device or the like configured with software and/or circuitry (e.g., a processor as summarized above) to process any or all of the method operations disclosed herein as embodiments of the invention. Still other embodiments of the invention include software programs such as a Java Virtual Machine and/or an operating system that can operate alone or in conjunction with each other with a multiprocessing computerized device to perform the method embodiment steps and operations summarized above and disclosed in detail below. One such embodiment comprises a computer program product that has a non-transitory computer-readable storage medium including computer program logic encoded thereon that, when performed in a multiprocessing computerized device having a coupling of a memory and a processor, programs the processor to perform the operations disclosed herein as embodiments of the invention to carry out data access requests. Such arrangements of the invention are typically provided as software, code and/or other data (e.g., data structures) arranged or encoded on a non-transitory computer readable storage medium such as an optical medium (e.g., CD-ROM), floppy or hard disk or other medium such as firmware or microcode in one or more ROM, RAM or PROM chips, field programmable gate arrays (FPGAs) or as an Application Specific Integrated Circuit (ASIC). The software or firmware or other such configurations can be installed onto the computerized device (e.g., during operating system execution or during environment installation) to cause the computerized device to perform the techniques explained herein as embodiments of the invention.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. An apparatus for forming additive structures comprising:
an extruder attached to at least one cable and adapted for movement over a rendering area while supported by the cable;
a plurality of cable support towers disposed adjacent to a rendering area, each of the towers adapted for supporting a respective cable;
at least one cable actuator in communication with at least one of the cables and configured to dispose the extruder over the rendering area; and
a feed vessel coupled to the extruder and configured to transport extrudate to the extruder for controlled deposition onto the rendering area.

2. The apparatus of claim 1 further comprising a cable actuator at each of the towers, the cable engaged with the actuator at a proximate end and attached to the extruder at a distal end, the cable actuators adapted to dispose the extruder for traversing the rendering area by retracting or extending the cables.

3. The apparatus of claim 1 wherein the cable actuator is disposed in the extruder, each cable of the at least one cable having a corresponding cable actuator, the cable further comprising an attachment to a respective one of the plurality of towers, the extruder configured to traverse above the rendering area by extending or retracting the cable relative to the respective tower.

4. The apparatus of claim 1 wherein the cable actuator is disposed in the extruder, the cable further comprising an attachment to a respective one of the plurality of towers, the extruder configured to traverse above the rendering area by drawing the actuator along the cable toward or away from the respective tower.

5. The apparatus of claim 1 further comprising a plurality of actuators, the extruder defining an end-effector of the collective cable manipulations from each of the towers, the corresponding actuators contributing to the parallel manipulations of the extruder, each of the actuators responsive to a common control for positioning the extruder at a location defined by fabrication logic.

6. The apparatus of claim 1 further comprising:
a hopper for containing extrudate for forming a fabricated structure; and
an extrudate pump coupled to the hopper for transporting the extrudate through the feed vessel, the feed vessel attached to the extrudate pump and suspended above the rendering area.

7. The apparatus of claim 6 wherein the extruder further comprises:
a nozzle in communication with the feed vessel for receiving extrudate; and
an extrusion pump coupled to the nozzle for dispensing precise quantities of extrudate onto the rendering area based on a position above the rendering area.

8. The apparatus of claim 1 further comprising fabrication logic for defining the rendering area and driving the actuators and extruder for additively forming the fabricated structure by controlled extrusion of the extrudate at predetermined locations in the rendering area.

9. The apparatus of claim 8 wherein each of the towers is a detached cable support and actuator, adapted to be disposed to an alternate location independently of the others of the plurality of towers.

10. The apparatus of claim 2 wherein the actuator is defined by a winch at each of the towers, further comprising fabrication logic, each of the actuators responsive to the fabrication logic to drive the winch for spooling and unspooling the cable for disposing the extruder at a height and location above the rendering area.

11. The apparatus of claim 5 wherein the towers are disposed outside a perimeter of the rendering area, the rendering area defining the limits of the fabricated structure resulting from the extrusion operations of the extruder.

12. The apparatus of claim 11 wherein each tower has a respective cable and actuator, each cable attached to the extruder for providing parallel manipulations of the extruder for three dimensional (3D) positioning over the rendering area.

13. The apparatus of claim 11 further comprising a plurality of cables attached to the extruder, each cable having a corresponding actuator in the extruder, the actuator configured to spool the cable to alter the length of the cable to a respective tower, the actuators providing parallel manipulations of the extruder by disposing the extruder over the rendering area based on the unspooled length of each cable for three dimensional (3F) positioning over the rendering area.

14. A method for forming additive structures comprising:
attaching an extruder to a plurality of cables for movement and support over a rendering area while supported by the cable;
supporting the cables from a plurality of cable support towers disposed adjacent to a rendering area, each of the towers adapted for supporting a respective cable;
positioning the extruder at predetermined positions over the rendering area by extending and retracting the cables; and
releasing extrudate from a feed vessel coupled to the extruder and configured to transport extrudate to the extruder for controlled deposition onto the rendering area.

15. The method of claim 14 further comprising invoking an actuator disposed in the extruder, each cable of the plurality of cables having a corresponding cable actuator, the cable further comprising an attachment to a respective one of the plurality of towers, the actuators configured to traverse above the rendering area by extending or retracting the cable relative to the respective tower.

16. The method of claim 15 further comprising spooling the cable using the actuators to alter the length of the cable to a respective tower, the actuators providing parallel manipulations of the extruder by disposing the extruder over the rendering area based on the unspooled length of each cable for three dimensional (3F) positioning over the rendering area.

17. The apparatus of claim 15 wherein the actuators and extruder are responsive to fabrication logic for defining the rendering area and driving the actuators and extruder for additively forming the fabricated structure by controlled extrusion of the extrudate at predetermined locations in the rendering area.

18. The apparatus of claim 17 wherein each of the towers is adapted to be disposed to an alternate location independently of the others of the plurality of towers, further comprising redeploying each of the towers at an alternate site.

19. An apparatus for generating 3 dimensional structures comprising:
a plurality of redeployable towers and bases adapted to transport a plurality of cables;
a drive source operable to traverse a rendering area by retracting or extending the cables;
an end-effector attached to at least one cable and operable to deposit extrudate onto the rendering area;
a pump in the end-effector configured to selectively deposit the extrudate at predefined locations based on a position of the cables; and
a control unit having control logic for directing the drive source, the cables responsive to the drive source for disposing the end-effector.

20. The apparatus of claim 19 further comprising an extrudate reservoir and a pump in fluidic communication with the reservoir, the pump operable to force the extrudate for deposition at the predefined location responsive to the control logic.
